(19) United States
(12) Patent Application Publication
(10) Pub. No.: US 2016/0306383 A1
(43) Pub. Date: Oct. 20, 2016

(54) MULTI-CARD SYNCHRONIZATION SYSTEM OF FUNDAMENTAL AND DIVIDED CLOCK FREQUENCIES

(71) Applicant: GE Intelligent Platforms, Inc., Charlottesville, VA (US)

(72) Inventors: James Andrew Harriman, Ottawa (CA); Dax Hockey, Huntsville, AL (US); Rodney Alan Durrett, Huntsville, AL (US); Kevin Teuscher Horrocks, Huntsville, AL (US)

(21) Appl. No.: 14/689,763

(22) Filed: Apr. 17, 2015

(51) Int. Cl. G06F 1/12; G06F 1/10

(52) U.S. Cl. CPC G06F 1/12; G06F 1/10

(57) ABSTRACT

Provided is a multi-card synchronization system for synchronizing fundamental and divided clock frequencies. The system includes a plurality of cards connected with a chassis, each card comprising one or more clocks to be synchronized, and one of the plurality of cards being a master card. The master card transmits a reference clock signal to each card including the master card, locks a phase of each card upon receiving the reference clock signal transmitted thereto, transmits a first phase-locked-loop (PLL) program signal to each card, and syncs the fundamental and divided clock frequencies of each card including the master card.

### TECHNICAL FIELD

The present invention relates generally to signal processing applications. In particular, the present invention relates to synchronization of fundamental and divided clock frequencies in signal processing applications e.g., sensor applications.

### BACKGROUND OF THE INVENTION

In systems employing sensor processing applications which include high speed Analog-to-Digital converters (ADC) and Digital-to-Analog converters (DAC), signals of cards attached to a backplane are obtained and processed within a single sample clock period. That is, synchronization of data is typically required to be within a single sample clock period. The signals are typically synchronized to one another to maintain efficient data flow within the system.

### SUMMARY OF THE EMBODIMENTS

The various embodiments of the present disclosure are configured to provide a multi-card synchronization system for synchronizing the fundamental and divided clock frequencies in each card of the system, and the phases thereof for each card of the system.

In one exemplary embodiment, a multi-card synchronization system for synchronizing fundamental and divided clock frequencies is provided. The system includes a plurality of cards connected with a chassis e.g., a backplane, each card including one or more clock(s) to be synchronized, and one of the plurality of cards being a master card. The master card transmits a reference clock signal to each card including the master card, locks the phase of each card upon receiving the reference clock signal transmitted thereto, transmits the phase-locked-loop (PLL) programming signal(s) to each card, and syncs the fundamental and divided clock frequencies of each card including the master card.

In another exemplary embodiment, a method is provided. The method includes transmitting, via the master card, a reference clock signal to a plurality of cards including the master card, locking, via a PLL device, a phase of each card upon receiving the reference clock signal transmitted thereto, transmitting, via the master card, a first PLL program signal to each card, and syncing, via the master card, the fundamental and divided clock frequencies of each card including the master card thereto.

The foregoing has broadly outlined some of the aspects and features of various embodiments, which should be construed to be merely illustrative of various potential applications of the disclosure. Other beneficial results can be obtained by applying the disclosed information in a different manner or by combining various aspects of the disclosed embodiments. Accordingly, other aspects and a more comprehensive understanding may be obtained by referring to the detailed description of the exemplary embodiments taken in conjunction with the accompanying drawings, in addition to the scope defined by the claims.

### DESCRIPTION OF THE DRAWINGS

FIG. 1 is a block diagram illustrating is a multi-card synchronization system that can be implemented within one or more embodiments of the present invention.

FIG. 2 is a block diagram of a master card of the system shown in FIG. 1 that can be implemented within one or more embodiments of the present invention.

FIG. 3 is a block diagram of a slave card of the system shown in FIG. 1 that can be implemented within one or more embodiments of the present invention.

FIG. 4 is a block diagram of a divided clock alignment circuit of the system shown in FIG. 1 that can be implemented within one or more embodiments of the present invention.

FIG. 5 is a timing diagram of an exemplary alignment operation performed by the circuit shown in FIG. 4.

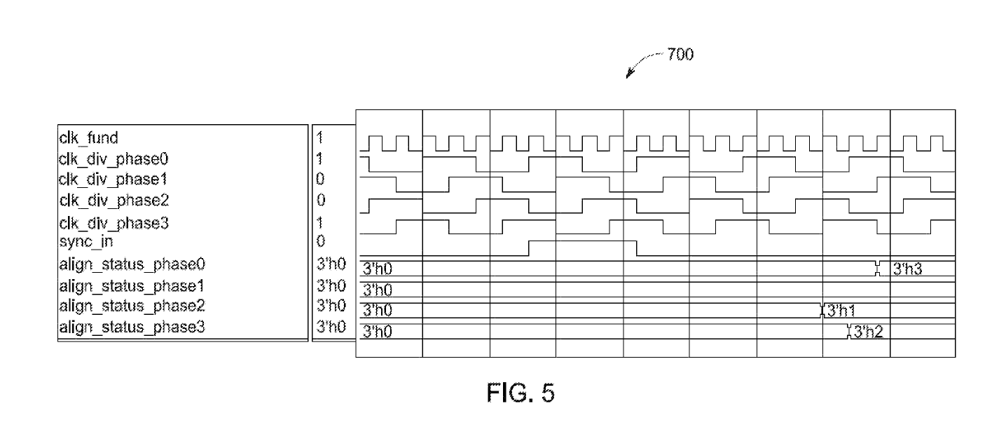

FIG. 6 is a flow diagram illustrating an exemplary synchronization method that can be implemented in an embodiment of the present invention.

FIG. 7 is a flow diagram illustrating an exemplary alignment method that can be implemented in an embodiment of the present invention.

The drawings are only for purposes of illustrating preferred embodiments and are not to be construed as limiting the disclosure. Given the following enabling description of the drawings, the novel aspects of the present disclosure should become evident to a person of ordinary skill in the art. This detailed description uses numerical and letter designations to refer to features in the drawings. Like or similar designations in the drawings and description have been used to refer to like or similar parts of embodiments of the invention.

### DETAILED DESCRIPTION OF THE EMBODIMENTS

As required, detailed embodiments are disclosed herein. It must be understood that the disclosed embodiments are merely exemplary of various and alternative forms. As used herein, the word “exemplary” is used expansively to refer to embodiments that serve as illustrations, specimens, models, or patterns. The figures are not necessarily to scale and some features may be exaggerated or minimized to show details of particular components. In other instances, well-known components, systems, materials, or methods that are known to those having ordinary skill in the art have not been described in detail in order to avoid obscuring the present disclosure. Therefore, specific structural and functional details disclosed herein are not to be interpreted as limiting, but merely as a basis for the claims and as a representative basis for teaching one skilled in the art.

Exemplary embodiments of the present invention provides a synchronization system and method of synchronizing fundamental and divided clock frequencies and phases in the plurality of cards of the system. The system employs a plurality of control systems (e.g., PLL devices) to lock the phases and a clock alignment circuit to align the divided clock signals of each card. The present invention may be employed in any application requiring synchronization of clocks within the system, where the proximity of the clocks allows signals to be distributed between the subsystems within the system. For example, the present invention may be employed in any sensor or telecommunication systems including radar systems.

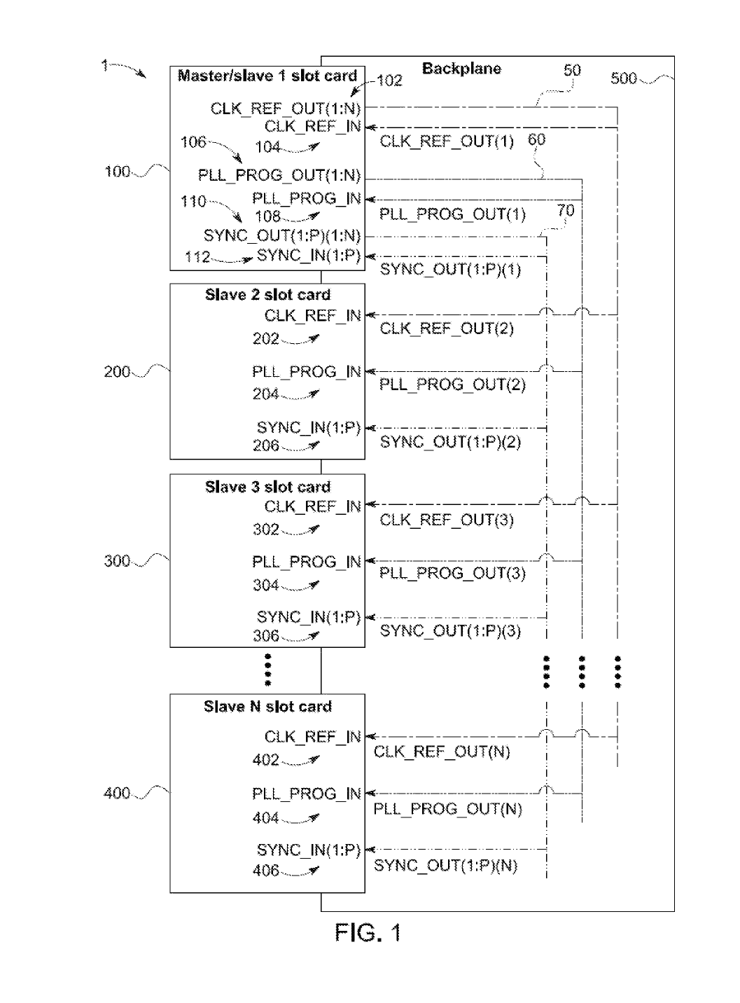

FIG. 1 is a block diagram illustrating is a multi-card synchronization system 1 that can be implemented within one or more embodiments of the present invention. As shown, a plurality of cards including a master card 100 and N number of slave cards 200, 300 and 400 are connected to a chassis (e.g., a backplane 500).

The backplane 500 includes dedicated wiring which selects a card to be assigned as the master card 100. Software is also included which receives information concerning the selected card, during implementation. The master card 100 also acts as a slave card in that it receives the same signals as that of the slave cards 200, 300 and 400. Each card including the master card 100 and the slave cards 200, 300 and 400 includes a plurality of input and output ports for transmitting and receiving signals. The master card 100 includes a reference clock signal output 102 for outputting a reference clock signal 50 (for example of approximately 10 MHz) to the slave cards 200, 300 and 400, and a reference clock signal input 104 for receiving the reference clock signal 50.

The master card 100 further includes one or more PLL program signal output(s) 106 for outputting a PLL program signal 60 to the slave cards 200, 300 and 400 driven by the master card 100 and aligned to a falling or rising edge of the reference clock signal 50, and one or more PLL program signal input(s) 108 for receiving the PLL program signals 60. The master card 100 further includes at least one sync signal output 110 for outputting one or more sync signal(s) 70 to the slave cards 200, 300 and 400, and a sync signal input 112 for receiving the sync signal 70.

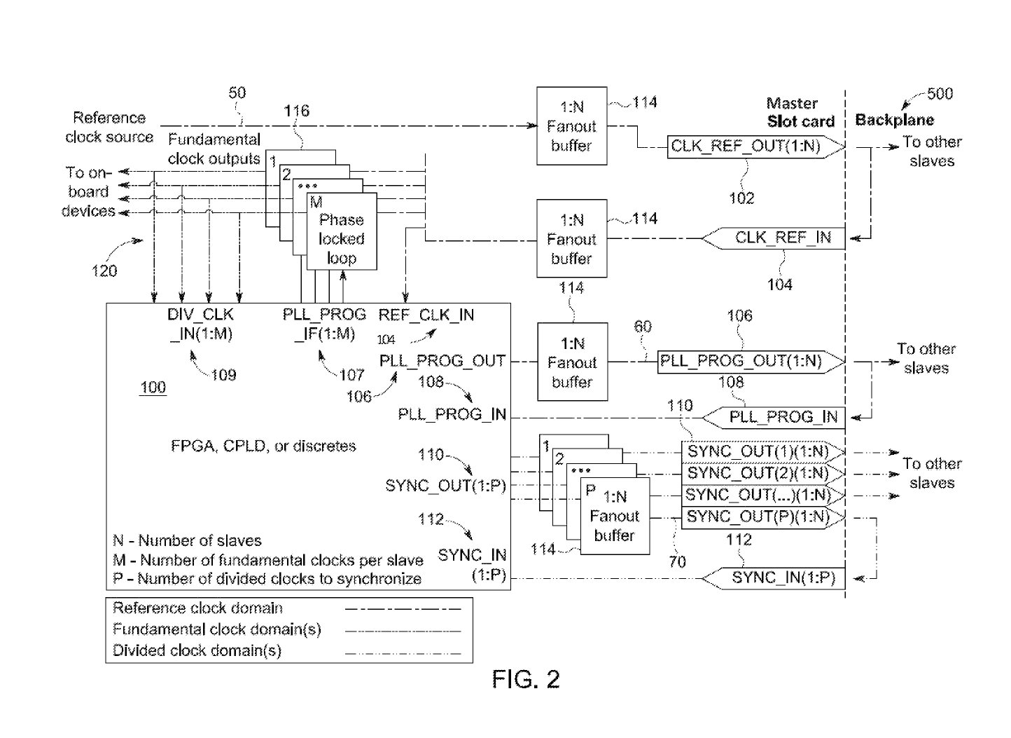

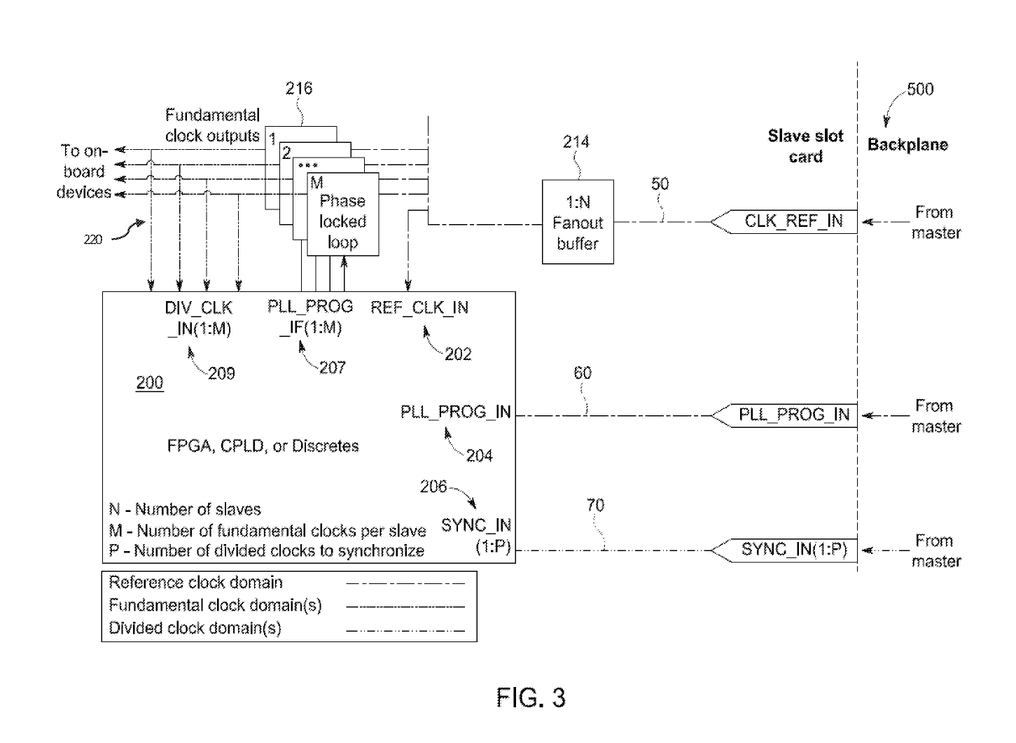

Each slave card (200, 300, and 400) respectively includes clock(s) to be synchronized, a reference clock signal input (202, 302, and 402), PLL program signal input(s) (204, 304 and 404), and a sync signal input (206, 306 and 406) for receiving the respective signals 50, 60 and 70. Additional details regarding the synchronization process will be discussed below with reference to FIGS. 2 and 3.

FIG. 2 is a block diagram of the master card 100 of the system 1 shown in FIG. 1, the master card 100 further includes a second PLL program input/output 107 and a divided clock signal input 109. FIG. 3 is a block diagram of a slave card of the system shown in FIG. 1 that can be implemented within one or more embodiments of the present invention.

The master card 100 transmits a reference clock signal 50 from a reference clock source, through a buffer 114, 214 to each slave card 200, 300 and 400 and to itself. That is, the master card 100 also acts a slave card and receives the reference clock signal 50 back.

The master card further comprises a plurality of PLL devices 116 corresponding to a number of fundamental clocks for each card 100, 200, 300 and 400. The reference clock signal 50 is received at an input of the PLL devices 116, 216 and is phase-locked. A first PLL program signal 60 is then transmitted to each card 100, 200, 300 and 400 to program each PLL device 116, 216 of each slave card 200, 300, and 400 and the master card 100. According to an embodiment of the present invention, the PLL programming signal(s) 60 are driven from the master card 100 and aligned to the falling edge of the reference clock signal 50.

The PLL devices 116, 216 of each card 100, 200, 300 and 400 receive a second PLL program signal from a second PLL program signal input/output 107, 207 at a same rising edge of the reference clock signal 50 and the output clock signals are of a same phase regardless of the frequency outputting by the respective PLL devices 116, 216 and inputting at divided clock signal input(s) 109, 209.

According to an embodiment, the PLL device 116, 216 is a control device that generates an output signal whose phase is related to the phase of an input signal and includes a variable frequency oscillator and a phase detector according to one or more embodiment. The present invention is not limited to any particular type of control devices and may vary accordingly. According to an embodiment, all the PLL devices 116 and 216 on each card 100, 200, 300 and 400 are programmed independently using a local program interface at the respective card 100, 200, 300 and 400.

The master card 100 is further configured to synchronize a sync signal 70 to a divided clock signal 120 of the master card 100, and transmit the sync signal 70 to each card 100, 200, 300 and 400, to synchronize the divided clock signals 120 at each card, 100, 200, 300 and 400. According to an embodiment, a number of sync signals 70 output by the master card 100 correspond to a number of divided clock signals 120 to be aligned in the system 1. Alternatively, according to another embodiment, a single sync signal 70 is output to each card 100, 200, 300 and 400 for the divided clock signals 120 thereof, using a staged alignment sequence or a multiplexer.

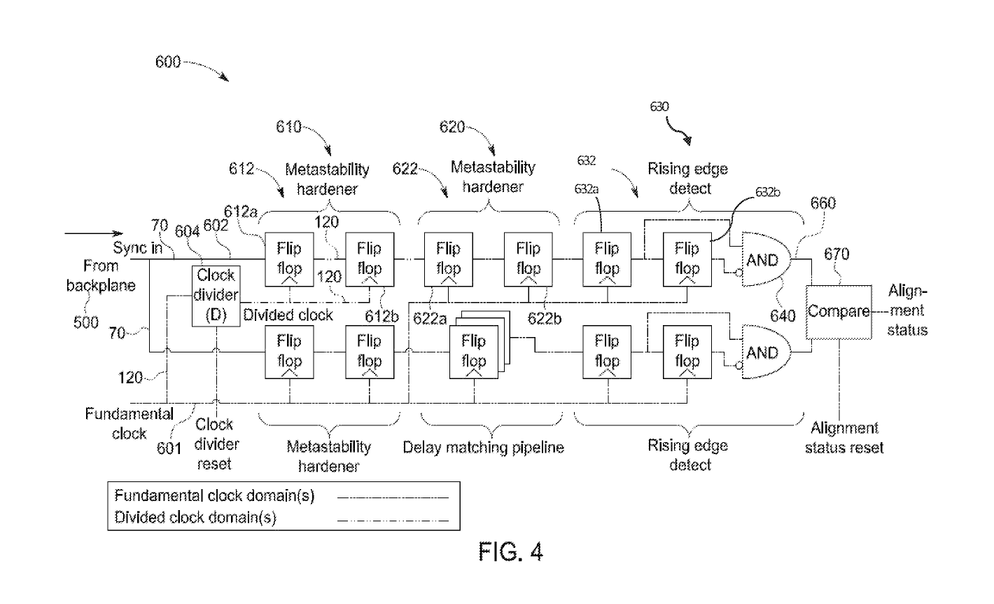

Embodiments of the present invention may be implemented within a system which requires divided down copies of sampling frequencies for various applications including data serialization and deserialization and trigger generation. To ensure that the divided down signals have a same phase clock output across the cards 100, 200, 300, and 400, the system 1 further includes a divided clock alignment circuit 600 as shown in FIG. 4. As shown, the divided clock alignment circuit 600 is configured to receive the sync signal 70 from each card 100, 200, 300 and 400.

According to an embodiment, the divided clock alignment circuit 600 includes a fundamental clock path 601, a divided clock path 602, and a clock divider 604 generating a divided clock signal 120. The sync signal 70 is received in the fundamental clock path 601 and the divided clock path 602 in a first metastability hardener stage 610.

The first metastability hardener stage 610 comprises two stages of flip flops 612 and the divided clock signals 120 are input into a pair of flip flops 612a and 612b at a first stage of the two stages 612 of flip flops.

Further as shown, the sync signal 70 from the divided clock path 602 is crossed over into the fundamental clock path 601 using a second metastability hardener stage 620. As shown, the second metastability hardener stage 620 also comprises at least two stages of flip flops 622 including pairs of flip flops 622a and 622b. The sync signal 70 in the fundamental clock path 601 is pipelined through the clock alignment circuit 600 to match any latencies difference between the fundamental clock path 601 and the divided clock path 602.

As shown, the divided clock alignment circuit 600 is further configured to detect a rising edge of the reference clock signal 50 on the fundamental clock path 601 and the divided clock path 602 using the sync signal 70 on the fundamental clock path 601. This occurs in a rising edge detection stage 630 downstream the first metastability hardener stage 610 and the second metastability hardener stage 620, which comprises pairs of stages of flip flops 632.

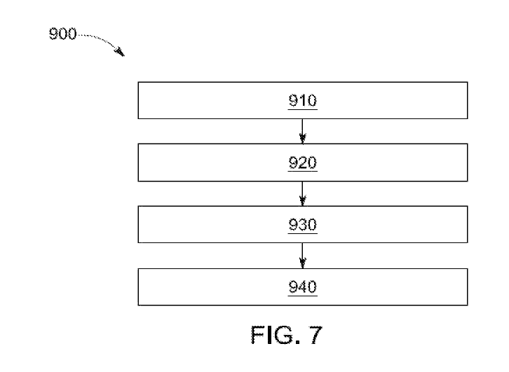

Flip flops 632 include flip flops 632a and 632b. Signals 660 are output and are shifted in time with each other based on a phase of the divided clock signal 120 on each card 100, 200, 300 and 400 at a plurality of AND gates 640. Thus, the divided clock alignment circuit 600 is further configured to compare via a comparator 670, and align phases of the divided clock signals 120 to be the same. An alignment operation is discussed below with reference to FIG. 7.

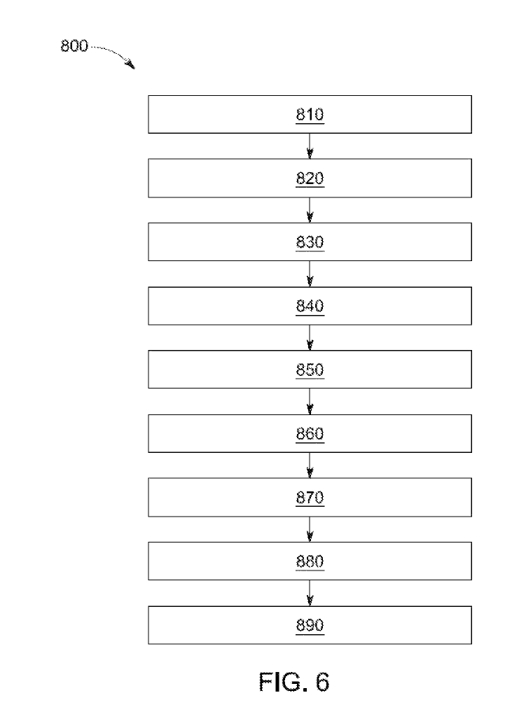

An exemplary timing diagram 700 illustrating an alignment operation of the divided clock alignment circuit 600 is shown in FIG. 6.

In this example, the clock signal is divided by four (4), and four (4) instances of the circuit 600 illustrate the four different possible clock phases. A sync signal 70 is sent out aligned to phase 0 and the circuit 600 returns a different alignment status for each instance. The alignment process 800 discussed below is performed on each slave card 100, 200, 300, 400 clock divider instance until the slave card 100, 200, 300 or 400 alignment status matches the master card 100 alignment status.

In FIG. 6, the method 800 for synchronizing fundamental and divided clock frequencies in a multi-card synchronization system 1 including a plurality of cards (e.g., the master card 100 and slave cards 200, 300 and 400) is provided. The method begins at operation 810 by transmitting, via the master card 100, a reference clock signal 50 to the cards 100, 200, 300 and 400.

The process continues to operation 820 where a phase of each card 100, 200, 300 and 400 is locked upon receiving the reference clock signal 50 transmitted thereto. Next, at operation 830, a first PLL program signal is transmitted via the master card 100, to each card 100, 200, 300, and 400.

In operation 840, the master card 100 syncs the fundamental and divided clock frequencies of each card 100, 200, 300 and 400.

The process then continues to operation 850 where the first PLL program signal is aligned to a falling edge of the reference clock signal 50 and transmitted from the master card 100 to each PLL device 116 and 216 on each card 100, 200, 300 and 400. Next, in operation 860, a second PLL program signal 60 is received at a same rising edge of the reference clock signal 50, and the fundamental clock frequencies output from the PLL devices 116 and 216 have a same phase.

The divided clock signals 120 are further aligned via operations 870 through 890.

In operation 870, a sync signal 70 is synchronized to a divided clock signal 120 of the master card 100 and transmitted to each card 100, 200, 300 and 400, to synchronize a divided clock signal 120 and 220 at each card 100, 200, 300 and 400.

At operation 880, the sync signal 70 from each card 100, 200, 300 and 400 is received within the fundamental clock path 601 and a divided clock path 602 of the divided clock alignment circuit 600 to be aligned as discussed above.

If the phases are not aligned, at operation 890 a phase aligning reset operation is performed as shown in FIG. 7, to reset the alignment of the phases to be the same.

The method 900 of FIG. 7 will be described with reference to FIGS. 2 and 3. The method 900 begins at operation 910 by resetting an alignment status at each card 100, 200, 300. From operation 910, the process then proceeds to operation 920 where a sync signal 70 is generated at each card 100, 200, 300 and 400.

Next, in operation 930, alignment of the phase of the divided clock signal of the master card 100, and the phase of the divided clock signal of each other card 200, 300, and 400 is separately detected, to determine if the phase of the divided clock signal 120 of each other card 200, 300 and 400 matches that of the master card 100.

In operation 940, if the phases are not aligned, the process returns to operation 910 and the steps are repeated.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A multi-card synchronization system for synchronizing fundamental and divided clock frequencies, the system comprising:
a plurality of cards connected with a backplane, each card comprising one or more clocks to be synchronized, and one of the plurality of cards being a master card,
wherein the master card is configured to:
transmit a reference clock signal to each card including the master card,
lock a phase of each card upon receiving the reference clock signal transmitted thereto,
transmit a first phase-locked-loop (PLL) program signal to each card, and
sync the fundamental and divided clock frequencies of each card including the master card.

2. The system of claim 1, further comprising a plurality of PLL devices corresponding to each card and communicating with the master card for locking the phase of each card, wherein the PLL devices on each card receive the first PLL program signal from the master card, the first PLL program signal being aligned to a falling edge of the reference clock signal.

3. The system of claim 2, wherein each PLL device is configured to receive a second PLL program signal at a same rising edge of the reference clock signal and the fundamental clock frequencies output from the PLL devices have a same phase.

4. The system of claim 3, wherein the master card is further configured to synchronize a sync signal to a divided clock signal of the master card, and transmit the sync signal to each card, to synchronize a divided clock signal at each card.

5. The system of claim 4, wherein a number of sync signals output by the master correspond to a number of divided clock signals to be aligned in the system.

6. The system of claim 5, wherein a single sync signal is output to each card for the divided clock signals thereof, using a staged alignment sequence.

7. The system of claim 6, further comprising a divided clock alignment circuit configured to receive the sync signal from each card.

8. The system of claim 7, wherein the divided clock alignment circuit comprises a fundamental clock path, a divided clock path, and a clock divider generating a divided clock signal, wherein the sync signal is received in the fundamental clock path and the divided clock path in a first metastability hardener stage.

9. The system of claim 8, wherein the first metastability hardener stage comprises two stages of flip flops, wherein the divided clock signals are input into a pair of flip flops at a first stage of the two stages of flip flops.

10. The system of claim 9, wherein the sync signal from the divided clock path is crossed over into the fundamental clock path domain using a second metastability hardener stage.

11. The system of claim 10, wherein the second metastability hardener stage comprises at least two stages of flip flops.

12. The system of claim 11, wherein the sync signal in the fundamental clock path is pipelined through the clock alignment circuit to match any latencies between the fundamental clock path and the divided clock path.

13. The system of claim 12, wherein the clock alignment circuit is further configured to detect a rising edge of the reference clock signal on the fundamental clock path and the divided clock path using the sync signal on the fundamental clock path, in a rising edge detection stage downstream the first metastability hardener stage and the second metastability hardener stage, and output pulses shifted in time with each other based on a phase of the divided clock signal on each card.

14. The system of claim 13, wherein the clock alignment circuit is further configured to align phases of the divided clock signals to be the same.

15. A method for synchronizing fundamental and divided clock frequencies in a multi-card synchronization system including a plurality of cards with one of the plurality of cards being the master card, the method comprising:
transmitting, via the master card, a reference clock signal to a plurality of cards including the master card;
locking, via a phase-locked-loop (PLL) device, a phase of each card upon receiving the reference clock signal transmitted thereto;
transmitting, via the master card, a first PLL program signal to each card; and
syncing, via the master card, the fundamental and divided clock frequencies of each card including the master card thereto.

16. The method of claim 15, further comprising:
aligning the first PLL program signal to a falling edge of the reference clock signal;
transmitting the first PLL program signal from the master card to each PLL device on each card.

17. The method of claim 16, further comprising:
receiving a second PLL program signal at a same rising edge of the reference clock signal, wherein the fundamental clock frequencies output from the PLL devices have a same phase.

18. The method of claim 17, wherein syncing the divided clock frequencies further comprises:
synchronizing a sync signal to a divided clock signal of the master card; and
transmitting the sync signal to each card, to synchronize a divided clock signal at each card.

19. The method of claim 18, further comprising:
receiving the sync signal from each card within a fundamental clock path and a divided clock path of a divided clock alignment circuit;
performing a crossover of the sync signal from the divided clock path into the fundamental clock path;
generating, via a clock divider, a divided clock signal and transmitting the divided clock signal in a first stage of the divided clock path; and
pipelining the sync signal in the fundamental clock path through the divided clock alignment circuit to match any latencies between the fundamental clock path and the divided clock path.

20. The method of claim 19, further comprising:
detecting a rising edge of the reference clock signal on the fundamental clock path and the divided clock path using the sync signal on the fundamental clock path; and
outputting output signals shifted in time with each other based on a phase of the divided clock signal on each card.

21. The method of claim 20, further comprising:
aligning the phases of the divided clock signals to be the same.

22. The method of claim 21, wherein if the phase of the divided clock signals are unequal, performing a phase aligning reset operation to reset the alignment of the phases to be the same.

23. The method of claim 22, wherein performing the phase aligning reset operation comprises:
resetting an alignment status at each card;
generating a sync signal at each card; and
separately detecting alignment of the phase of the divided clock signal of the master card, and the phase of the divided clock signal of each other card to determine if the phase of the divided clock signal of each other card matches that of the master card.
